(19) United States
(12) Patent Application Publication
(10) Pub. No.: US 2015/0299911 A1
(43) Pub. Date: Oct. 22, 2015

(54) Endless Fibres on the Basis of Hyaluronan Selectively Oxidized in the Position 6 of the N-Acetyl-D-Glucosamine Group, Preparation and Use Thereof, Threads, Staples, Yarns, Fabrics Made Thereof and Method for Modifying the Same

(71) Applicant: CONTIPRO BIOTECH S.R.O., Dolni Dobrouc (CZ)

(72) Inventors: Jiri Betak, Dolni Ujezd (CZ); Radovan Buffa, Humenne (SK); Miroslava Nemcova, Chocen (CZ); Tomas Pitucha, Bila Tremesna (CZ); Jaromir Kulhanek, Pardubice (CZ); Ilona Matejkova, Usti nad Orlici (CZ); Jana Novakova, Lanskroun (CZ); Lucie Vistejnova, Kralovice (CZ); Pavel Klein, Dolni Dobrouc (CZ); Gabriela Kubickova, Vamberk (CZ); Marketa Broulikova, Ceska Trebova (CZ); Michaela Felgrova, Usti nad Orlici (CZ); Vladimir Velebny, Zamberk (CZ)

(21) Appl. No.: 14/647,595

(22) PCT Filed: Nov. 26, 2013
(86) PCT No.: PCT/CZ2013/000157

§ 371 Date: May 27, 2015

(30) Foreign Application Priority Data
Nov. 27, 2012 (CZ) PV 2012-843

(51) Int. Cl. D01F 11/00; D06M 13/144; D03D 3/02; D03D 25/00; D04H 13/00; D01D 5/06; C08L 5/08

(52) U.S. Cl. CPC D01F 11/00; D01D 5/06; D06M 13/144; C08L 5/08; D03D 25/00; D04H 13/00; D03D 3/02; D10B 2331/06

(57) ABSTRACT

The present invention relates to the preparation of textile processable endless monofilaments and multifilaments on the basis of hyaluronan which has been selectively oxidized to aldehyde in the position 6 of its/V-acetyl-D-glucosamine group and to the subsequent modification of such filaments with low molecular dihydrazides. The fibres as well as the fabrics, which are subsequently prepared from the former, exhibit a time-varying solubility in saline depending on the external modification of the fibres. After having been externally modified, the fibres as well as the fabrics exhibit a prolong period of transition into an evenly distributed gel layer. The externally modified fibrous materials retain their full biocompatibility.

Endless fibres on the basis of hyaluronan selectively oxidized in the position 6 of the N-acetyl-D-glucosamine group, preparation and use thereof, threads, staples, yarns, fabrics made thereof and method for modifying the same

### FIELD OF THE INVENTION

The invention relates to the preparation and subsequent textile processing of endless fibres on the basis of hyaluronan, which is selectively oxidized in the position 6 of the N-acetyl-D-glucosamine group, the endless fibres exhibiting improved processing properties with respect the a prolonged period of transformation into a biocompatible gel.

### BACKGROUND OF THE INVENTION

The hyaluronic acid or hyaluronan belongs to the group of non-sulphated glycosaminoglycans consisting of consecutive disaccharidic units formed by N-acetyl-D-glucosamine and D-glucuronic acid. The substance commonly occurs in the human organism, predominantly in the body fluids which ensure the viscosupplementation or lubrication of the tissues (the substance is, e.g. contained in the synovial fluid or in the vitreous humour). The related literature describes favourable effects of the substance on wound healing since it supports the granulation of the regenerating tissue during the early stages of the healing process. For that reason, the substance belongs among the most sought-after constituents of healing formulations. One of the defined characteristics of hyaluronic acid is its affinity for the cellular receptors of the CD44 type which can be utilized, e.g., for a targeted cell regulation by means of specific medicines which are bound to hyaluronan. Another fact, which is known from the related literature, consists in that the above mentioned affinity of hyaluronan for the cellular receptors of the CD44 type is contingent on the presence of a free carboxyl group in the disaccharide unit of hyaluronan.

Hyaluronic acid is readily degradable in the human body by means of enzymes, which are capable of selective cleaving glycosidic bonds, whereby the molecular mass is gradually reduced up to saccharidic mer units which are subsequently metabolized in the human organism.

Owing to its lubricating and healing properties, hyaluronic acid is frequently utilized in the form of a viscous hydrogel for increasing the bio-acceptance of medical implants. However. lubricating gel formulations for internal application have certain disadvantages, such as uneven distribution of the gel in the area of application.

An more even distribution can be effectively achieved by applying a planar or tubular fabric made of gradually gellating fibres. Such fabrics, which are made from a material constituting the subject matter of the present patent application, have not been described in the related literature so far. In comparison with a gel form, the initial form of a dry fabric provides a considerable advantage related to the increased flexibility and improved mechanical properties. Unlike a spreadable gel, the applied fabric can be exactly tailored in accordance with the nature of the respective internal lesion during insertion. In addition, the amount of the applied gel can be further adjusted by using a variable mesh size within the respective textile bond.

For the reasons related to the way of application, it is essential that the fibres (or the fabrics themselves) exhibit particular antiadhesive properties during the initial stage in order to avoid an immediate adhesion to the moist tissue which would restrict the possibilities of a subsequent surgical alignment or displacement of the fabric within the application site. Consequently, a specific, sufficiently long handling stability of the textile material is desirable.

The creation of fibres and fabrics from the pure hyaluronic acid or from a salt thereof in its native form is described in two patent applications, namely in the documents WO2009/050389 and PV2010-1001.

The authors of the first of the above mentioned patent applications (WO2009/050389) describe the possible method of preparing fibres from hyaluronic acid or from its salt 20% by extruding the same into concentrated acetic acid having the permissible water content of up to 20% (i.e. into a solution of acetic acid having a concentration of up to 80%). The authors of the other of the above mentioned patent applications (PV2010-1001) describe the possible method of preparing fibres by coagulating a polymeric solution into a mixture of an inorganic acid and an alcohol (in the appended patent claims, the proportional amounts of both the components are specified in the range of 1-99% by weight and the preferred succession of inorganic acids includes formic acid, acetic acid and propionic acid).

Although the preparation of the fibres by extruding the original substance into the above mentioned precipitation baths leads, according to the statement of the authors, to the formation of a fibrous product, the use of such baths, which contain the above mentioned acids, can be indisputably found problematic from the technological point of view, at least with regard to an extremely strong pungent odour and to the fact that the vapours of the above mentioned acids constitute a real safety risk for the operators of the respective spinning device. The above problem has to be solved by introducing relatively complicated and expensive technological measures in the course of the manufacturing process. The information relating to the toxic properties of the above substances for the human organism cannot be found in other resources than in the screening literature ones (Wikipedia). In the human body, formic acid is metabolized into methanol. An elevated concentration of the latter substance may cause a permanent damage to the optic nerve. Furthermore, a possible renal impairment caused by the formic acid has been described. Acetic acid is, again, characterized by an intense odour. Due to its high volatility, its vapours also cause severe corrosion of mucous membranes, especially when highly concentrated solutions are present. The last of the three above mentioned acids, namely propionic one, is a generally recognized liver toxin causing propionic acidemia (source: Wikipedia).

The fibres on the basis of native hyaluronic acid, which are described in the above discussed patents, are characterised by an extremely high affinity for water. This affinity causes the fibres to get dissolved within ones to tens of seconds after having been exposed to a humid environment. Such period of time is not practically sufficient for the situations when the surgeon has to hold the fibrous material, which is to be inserted into the application site, in damp gloves. For the above reasons, the textile materials, which are formed purely from filaments on the above basis, are practically not suitable for surgical applications.

Hence, it is generally desirable to provide textile materials on the basis of cross-linked hyaluronic acid having its chains interconnected by means of transverse chemical bonds or by means of bonds being of a purely physical nature (i.e. based on electrostatic or hydrophobic interactions).

On the above basis, the related literature describes methods for preparing fibres from various chemically modified hyaluronans. The aim of those methods is to achieve a maximum extent of stabilization of the prepared fibres with respect to their solubility. Such stabilized fibres should assume a swollen form and reside in the bodily application site as long as possible.

The patent document US2006/0281912 A1 discloses a method for preparing fibres from hyaluronic acid modified by means of cetyltrimethylammonium, wherein the modification causes a carboxyl group on the glucuronic portion of hyaluronan to be blocked. This gives rise to the situation when the polymer, which has been modified in the above manner, loses its capability of being stabilized with hydrogen bridges and the main interchain cohesion function, i.e. cohesion between the individual chains, is taken over by the newly created hydrophobic interactions of long (C16-cetyltrimethylammonium) lateral aliphatic chains. However, such interactions are substantially less strong than the above mentioned hydrogen bridges. This makes hyaluronan derivates, which have been modified in the above described manner, susceptible to thermal lability. After having been modified in the above described manner, hyaluronan is processed by spinning. For this purpose, the spunmelt method is used. Nevertheless, an important question still remains open, namely that relating to the influence of blocking the carboxyl groups of hyaluronan on the biological properties of the same because this particular type of the functional groups of hyaluronan are generally considered to be determinative for the properties thereof.

The patent applications WO2010095049A1 and WO2010095056 A2 further describe the preparation of fibres using the wet spinning method. In this case, the fibres made of a pair of differently modified hyaluronans are subsequently cross-linked using the so called “click” reaction. After having been cross-linked in the above manner, the fibres also exhibit a considerably improved hydrolytic resistance in comparison with the fibres made of native hyaluronan. The above described cross-linking of hyaluronan chains takes place between two types of polymeric chains having different functional groups (thiol, azide, alkine, alkene and carbonyl). Then, the reaction takes places on the basis of a cycloiding mechanism. During such reaction, predominantly five membered rings are formed. In this case, the cross-linking process is induced by a temperature increase. Again, the fibres prepared with the use of the above process exhibit a considerably improved hydrolytic stability and thus cannot be considered to be the elements which contribute to the formation of a hydrolytically soluble liquid lubricating gel in the location where the corresponding fibrous material is inserted into the body.

The hydrolytic stabilization of the fibres can be further achieved by means of photo-cross linking reactions which are described in the patent application WO 2010061005. In this case a methacrylated derivative of hyaluronan is used which forms a spatial polymeric network after having been exposed to UV radiation. In this particular case, however, the material used is questionable with regard to the toxicity of its degradation products since methacrylate grafts of poorly washed-out unaffected methacrylates can cause irritative reactions of the organism to occur. The methacrylate residues released in the course of the enzymatic degradation, which is undoubtedly taking place in this context, are described as carcinogenic substances. Although the cited patent preferably relates to the formation of tougher and more stable hydrogel materials, the particular form of the fibre is mentioned in one of the respective patent claims.

Another group of documents describing the formation of fibres from modified hyaluronan includes the patent applications WO 93/11803, WO 98/08876, U.S. Pat. No. 5,658,582, and US 2004/0192643 A1. All of them describe the formation of fibres from hyaluronan modified by the esterification of its carboxyl group. Again, the fibres are prepared by means of the wet spinning method and are characterised by prolonged stability. Thus, they cannot be used for the insertion into the body in the form of a fabric enabling a gradual formation and subsequent even distribution of a viscous gel.

The fibres, which are prepared according to the present patent application, are obtained from aqueous solutions of hyaluronan that has been selectively oxidized in the position 6 of its N-acetyl-glucosamine group. The final chemical structures of hyaluronan, which is modified in the above specific manner, are described by the authors of the related patents WO 2011/069475, WO 2011/069474, and CZ PV 2012-537 as follows: when taking place in the above manner, the selective oxidation leading to the formation of an aldehyde group does not cause any disruption of the pyranose saccharidic ring which means that no significant influencing of the linear supramolecular structure of the respective polysaccharidic chain occurs.

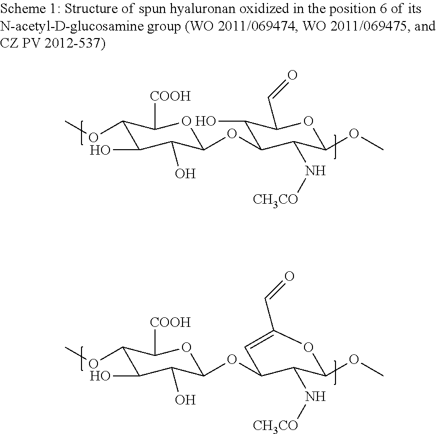

The preservation of the maximum straightness of the polymeric chain in spun polymers is generally considered to be favourable with regard to the formation of endless fibres having high mechanical strength because a higher extent of a parallel arrangement of the individual macromolecular chains can be obtained which, in turn, leads to the overall stabilization of the fibre (source: Hladik, Textile fibres). In this connection, the mechanical properties of endless monofilaments are critical for their subsequent textile processability.

The patent application US2004/0101546A1 describes the preparation of haemostatic textile materials which are obtained by means of an oxidizing reaction of a polysaccharidic fabric with NaIO₄, wherein the reaction produces external aldehyde groups (Scheme 2). The description of the exemplary embodiments, however, only describes the corresponding modifications of cellulose-based knitted fabrics and non-woven fabrics.

In the opinion of the authors, additional chemical bonds between the fabrics, which have been modified in the described manner, an low molecular amines (such as peptides) can be formed. The undesired unstable imine bond can be subsequently reduced by means of sodium borohydride, sodium cyano-borohydride or aminoboranes. However, the cited invention does not solve the issue of the formation of endless monofilament fibres in any way, which fibres would be separately textile processable in order to provide aldehyde bonds (stabilizing acetal bonds) within the entire volume of the fibre, i.e. not only on the surface of the same.

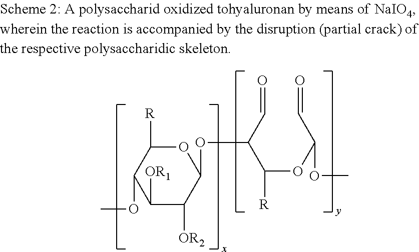

The prior art also includes the utilization of aldehyde-modified hyaluronan for the formation of cross-linked hydrogels which are subsequently used for the production of scaffold or carrier systems (EP1115433 B1, WO2010138074 A1, WO2009108100 A1).

In the related literature, no description of a technology used for the formation of endless fibres, threads, knitted fabrics of woven fabrics on the basis of hyaluronan oxidized to aldehyde in the position 6 of its N-acetyl-D-glucosamine group has been found which would be similar to the substance of the present invention as defined below.

### SUMMARY OF THE INVENTION

The subject-matter of the present invention lies in the method of manufacturing new, textile processable endless monofilaments, compound multifilaments or multifilament threads and subsequent manufacturing of textile processed products of the former, the filaments being based on hyaluronan which is selectively oxidized in the position 6 of its N-acetyl-D-glucosamine group and subsequently externally modified with low molecular dihydrazides. In comparison with the technical solutions constituting the prior art, the fibrous materials prepared in accordance with the present invention provide an advantage which consists in that they work as gel forming elements after having been inserted into the human body, their spontaneous transformation into a viscous gel, however, being time-shifted. The respective delay ranges between about 30 minutes (for non-modified fibres) and about 75 hours (for externally modified fibres). Subsequently, the effect of swelling forces causes the cross-linked surface of the fibres to disrupt, thus exposing the non-cross linked cores of the individual cores and initiating a gel-forming decomposition of the same.

The fibres made of oxidized hyaluronan, which are described within the framework of the present patent application, have their entire volumes stabilized by means of acetal bonds formed between the aldehyde groups and hydroxyl groups of the respective polymeric chain. The acetal bonds constitute hydrolytically unstable structures which subsequently, i.e. after moisturizing, gradually degrade until the total transformation of the fibre into a desired lubricating gel form is achieved. Despite that, such fibres exhibit a significantly longer lasting insolubility in comparison to those prepared from native hyaluronan. After having been immersed in water, the fibres/fabrics remain in a compact fibrous state for at least 30 minutes. This enables the fibres to be, for example, repeatedly grasped with tweezers without being torn apart during the above period. Hence, the fact that the fibres constitute a material, which is very similar to native hyaluronan from the chemical point of view, represents a useful potential. Therefore, even without being subsequently externally modified by cross-linking, the fibres according to the invention provide a material that is more suitable with regard to the ease of handling and fully biologically acceptable in comparison with the fibres prepared from native hyaluronan. During the application, the surgeon can handle such fibres, threads or fabrics made of the former or latter even in damp gloves. After the lapse of about 30 minutes, these fibres gradually transform into a lubricating gel. The prolonged period, in the course of which the above described endless filaments are being transformed into a biocompatible antiadhesive gel, can be further utilized, e.g., for developing composite threads or surgical fabrics, wherein a subsequent formation of an evenly distributed gel enhancing the overall biological acceptability of an internal textile implant is highly desirable.

Hence, the present invention particularly relates to the preparation of fibres based on hyaluronan which is selectively oxidized in the position 6 of its N-acetyl-D-glucosamine group, wherein first an aqueous solution of oxidized hyaluronan having the concentration of 4-6% by weight is prepared, which solution is then extruded into a coagulation bath containing lactic acid in the amount ranging between 5 and 45% by weight, preferably between 10 and 20% by weight, a lower alcohol in the amount of at least 50% by weight and water in the amount ranging between 4 and 10% by weight, causing a fibre to form, which is subsequently washed with a lower alcohol and dried. The lower alcohol used for washing the extruded fibre may be, for example, ethanol, 1-propanol or isopropanol. Similarly, the lower alcohol used in the coagulation bath may be, for example, ethanol, 1-propanol or isopropanol.

The prolonged period, during which the above described fibres are being transformed into a gel, can be further prolonged by creating a cross-linked structure on the surfaces of such fibres/threads or fabrics which can be accomplished in that the fibres are submerged into a cross-linking solution containing an alcohol (methanol, ethanol, propane-1-ol, propane-2-ol) in the amount of 70-80%, a low molecular dihydrazide of an organic acid and water in the amount of 20-30%, the presence of the latter being essential for the dissolution of the dihydrazide of an organic acid, for a period between 10 minutes and 24 hours. Due to the presence of the above small amount of water, the fibre gets slightly swollen whereby the absorption of dissolved di-hydrazides into the surface layer of the fibre is supported. However, the fibres must be dry before the stabilizing bath is applied because otherwise they would not be capable of absorbing the cross-linking bath containing dihydrazide. One of the advantageous examples of a low molecular dihydrazide of an organic acid represents the dihydrazide of succinic, adipic or pimelic acids with concentrations ranging from 5×10⁻⁶M to 0.01M, preferably however with the concentration of 5×10⁻³M, the application temperatures ranging between 20 and 50° C.

Due to the predominantly external character of the above described cross-linking process, a direct calculation of the amount of the used cross-linking agent cannot be performed because it is not obvious how many aldehyde groups are available for the reaction. This fact is very important with regard to the efficiency of the cross-linking process since an excess of dihydrazide causes the cross-linking reaction to cease and the retrograde decomposition of the cross-linked structure to occur. For this reason, the optimum concentration of the cross-linking agent is not obvious at first glance and can be only determined in an experimental manner.

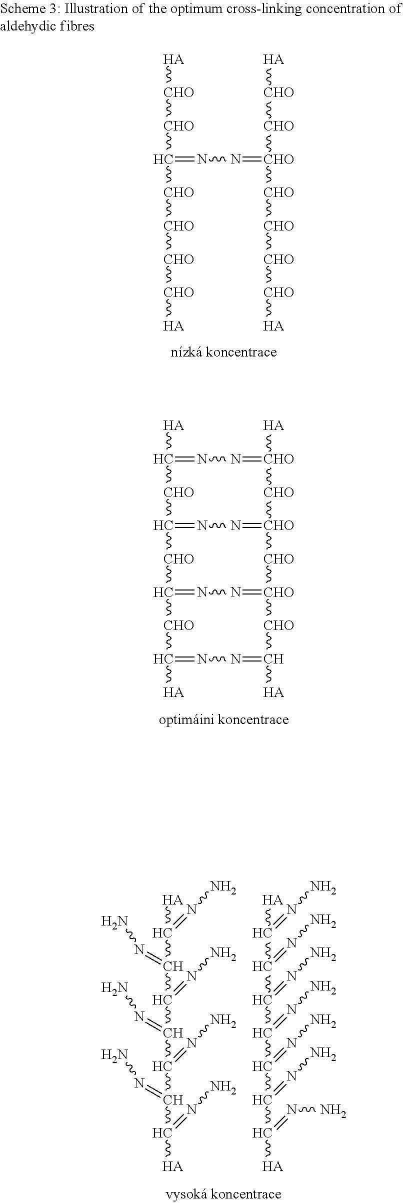

Even despite the above described subsequent modification, which causes a external cross-linked structure to form, the fibrous materials retain their full biological compatibility as well as their capability of transforming into gels in the humid physiological environment of the blood plasma and under the bodily temperature of 37° C. for a prolonged time period of up to 72 hours.

Owing to the above aspects including a significant prolongation of the period, during which the fibres remain stable, provide a practical advantage in comparison with the gel forming fibres prepared from native hyaluronan, i.e. with those according to the patent applications WO2009/050389 and PV2010-1001, because the latter rapidly decompose within tens of seconds, even just after coming into contact with a wet surgical glove. Besides that, the known fibres tend to adhere to such gloves. The fibres prepared on the basis of hyaluronan, which is selectively oxidized in the position 6 of its N-acetyl-D-glucosamine group, as described in the present patent application, can be considered to be gel forming material having a reduced adhesive capacity during the initial stage of its use.

Another important aspect and innovative approach proposed within the framework of the present patent application relates to the significant increase of efficiency, reduction of costs and mitigation of safety risks with regard to the spinning technology which is described within the framework of the discussion on the above mentioned relevant patents WO2009/050389 and PV2010-1001.

The formation of the endless fibres, which are described in the present patent application, using the method of gel extrusion (gel spinning) into a coagulation bath a mixture of a lower alcohol and lactic acid is advantageously used, which mixture is characterized by a low level of volatility. This enables an efficient elimination of the intense odour during the spinning process to be achieved, even if the spinning technologies mentioned in the above cited patents are used. At the same time, the risk of both acute and chronic impacts on the health of the operators of the respective spinning device can be minimized. Unlike the acids, which are mentioned in the above cited patent applications, lactic acid is considered to be entirely harmless for human health. Lactic acid is a chemical substance which is commonly present in muscular tissues and, besides that, is frequently used as an ingredient of various cosmetic products due to its above described antiseptic effects. Furthermore, lactic acid/lactate assuming its polymeric form is commonly used as a component of medical polymeric degradable implants prepared on the basis of polylactates (PLA) or on the basis of their copolymers with glycolic acid (PLGA). For the above reasons, possible residues of lactic acid remaining in the fibres/threads or fabrics, which have been prepared in accordance with the present patent application, are not considered completely undesirable.

The use of lactic acid instead the other acids, which are mentioned in the two above cited patents, cannot be considered to be a quite trivial solution which would be derivable by way of analogy. This is so because, unlike the other acids mentioned in the above cited patents, lactic acid is a solid crystalline substance. When it is present in the form of an aqueous solution having the standard concentration of 80%. lactic add provides a liquid having a substantially higher viscosity in comparison with all the other acid mentioned above, the latter being exclusively selected from the category of liquid substances. For the above reasons (particularly due to the different state of matter of the pure substance), the addition of lactic acid cannot be deemed to be a quite obvious technical solution. Moreover, the fact, that lactic acid could be used as a separate coagulating agent in place of all the above mentioned acids in the present context, cannot be considered to be an obvious assumption.

Instead, lactic acid can only become an efficient coagulating agent, which is usable for the formation of textile processable fibres on the basis of the above mentioned derivative (hyaluronan oxidized in the position 6 of its N-acetyl-D-glucosamine group), when it is used within a certain concentration range of the ternary mixture consisting of an alcohol, lactic acid and water, wherein the alcohol content of said mixture reaches at least 50% by weight. The conclusions of the related optimization research have shown that fibres, which have a sufficient mechanical strength, are only formed within a certain concentration range of the coagulating bath. Such bath preferably contains lactic acid in the amount ranging between 5 and 45% by weight and a proportional amount of added lower alcohol (ethanol, propane-1-01, propane-2-ol). In addition, the bath may contain water in the amount of 4-10% by weight. This is the only concentration range of the coagulating bath which enables a continually drawable fibre with a sufficient mechanical strength to be obtained. Considering the fact that the functional composition of a coagulation bath on the basis of lactic acid has to be found in an experimental manner, it is evident that the use of such a bath on the basis of lactic acid does not pose a trivial technical solution, contrary to the two above cited relevant patents W009/050389 and PV2010-1001, which are based on the assumption that the fibres on the basis on hyaluronan cam also be formed in a pure acid (formic, acetic or propionic one) exhibiting a substantially lower viscosity. As already mentioned hereinbefore, the vapours of such acids are considerably hazardous for health and, besides that, have stronger corrosive effects which results in increased demands on the materials of coagulation basins.

In case of a lower content of lactic acid in the coagulation bath, the fibres exhibit increased brittleness resulting from their total dehydration. Contrarily, higher concentration of lactic acid in the coagulation mixture make the bath ineffective due to its excessive viscosity.

The fibres can be also subjected to thermal loading within the temperature range from 75 to 85° C. for at least 12 hours, whereupon they are left to dry under a laboratory temperature. Then the fibres are subjected to the action of an alcoholic solution of diamino compounds, such as 1,6-diaminohexane, in order to become stabilized against hydrolysis. Following the thermal modification, a different type of aldehydic group (see above, Structure 2, Scheme 1) arises. The newly created dual bond exists in conjugation with the aldehydic group, whereby stronger bonding of a large variety of amino linkers is enabled in comparison with a fibre which has not undergone any thermal modification. The result is increased hydrolytic stability of the cross-linked structure obtained.

Furthermore, the present invention relates to fibres on the basis of hyaluronan, which is selectively oxidized in the position 6 of its N-acetyl-D-glucosamine group, which fibres may alternatively be externally cross-linked. Endless monofilaments (fibres) prepared by using the method according to the invention are characterized by prolonged geometric stability since the fibres, which assume a compact form, remain stable in water for several tens of minutes whereupon they gradually transform into a viscous biocompatible and biodegradable hydrogel. Moreover, they are characterized by a sufficient mechanical strength and flexibility. Owing to this, they can be combined into the form of fibre tows (non-twisted monofilaments) comprising two or more individual filaments or into the form of threads (twisted monofilaments) comprising two or more individual fibres. Furthermore, the fibres according to the invention can be used for manufacturing yarns, staples and woven, knitted or non-woven fabrics.

The present invention also relates to threads formed from the above fibres as well as to yarns formed by at least one fibre according to the invention and at least one fibre made of a different biodegradable material which is suitable for being used in surgical applications, e.g. (poly(2-hydroxyethylmethacrylate, poly(N-vinylpyrrolidone), poly(methyl methacrylate), poly(vinylalcohol), polyacrylic acid, poly(ethylen-co-vinylacetate), poly(ethylenglycol), poly(methacrylic acid), polylactates, polyglycolides, poly(lactide-co-glycolides), polyanhydrides, polyorthoesters, polycaprolaktone, polyhydroxyalkanoates, chitosan, collagen, or any combination thereof). The last but not least subject of the present invention is a fibrous staple on the basis of the fibres according to the invention and a yarn made of such staple.

The above described fibres, threads (twisted monofilaments), tows (non-twisted monofilaments), staples or yarns, alternatively in combination with other biodegradable fibrous materials, cab be used for the manufacture of woven, knitted and non-woven fabrics which can assume the form of a planar or tubular fabric or the form of a 3D scaffold.

Furthermore the present invention relates to a method for modifying the fibres, threads, fibrous staples, yarns and woven, knitted or non-woven fabrics according to the invention, wherein the same are subjected to the action of an aqueous alcoholic solution having its concentration between 70 and 80% and containing a low molecular dihydrazide of an organic acid, the hydrazide being present in the solution in a concentration between 5×10⁻⁶M and 0.01M, for a time period between 10 minutes and 24 hours and under the temperature between 20 and 50° C. The low molecular dihydrazide of an organic acid may be selected from the group comprising dihydrazide of succinic acid, dihydrazide of adipic acid or dihydrazide of pimelic acid.

### BRIEF DESCRIPTION OF THE DRAWINGS

FIG. 1 depicts the tear strengths measured during the repeated preparation of the fibres.

FIG. 2 depicts the tear deformations measured during the repeated preparation of the fibres.

FIG. 3 depicts the distribution of fineness during the repeated preparation of the fibres.

FIG. 4 depicts the viability test of fibrous materials formed from hyaluronan which has been selectively oxidized to aldehyde in the position 6 of its N-acetyl-D-glucosamine group.

FIG. 5 depicts the verification of non-toxicity of the degradation products of the fibres which are externally modified by means of dihydrazides (ADH—dihydrazide of adipic acid, PMADH—dihydrazide of pimelic acid and SAD—dihydrazide of succinic acid), wherein “Enzymes 100, 500 and 1000” refer to blank solutions without a fibrous content and with the concentrations of hyaluronidase enzymes of 100, 500 and 1000 μg/ml, respectively.

FIG. 6 shows a table containing the information on the solubility of externally modified fibres, wherein the modifications with dihydrazide adipate took place in different mediums. The solubility (degradation caused by swelling) in the given medium is marked on a scale from 0 to 4, where 4 refers to a completely dissolved fibre (corresponding to the loss of visual contact).

FIG. 7 depicts endless monofilaments and a twisted thread made of 5 endless monofilaments prepared from hyaluronan which had been selectively oxidized to aldehyde in the position 6 of its N-acetyl-D-glucosamine group.

FIG. 8 depicts the mechanical properties of a twisted thread made of 5 endless monofilaments prepared from hyaluronan which had been selectively oxidized to aldehyde in the position 6 of its N-acetyl-D-glucosamine group.

FIG. 9 shows an NMR record of an aldehydic hyaluronan which has been externally cross-linked by using a solution of dihydrazide adipate. After having undergone the reaction, the material became less soluble in water.

FIG. 10 shows an NMR record of thermally modified fibres prepared from hyaluronan, which is selectively oxidized in the position 6 of its N-acetyl-D-glucosamine group, wherein the thermal loading of the fibres causes the aldehydic groups to be converted to unsaturated α,β-aldehydes exhibiting a significantly increased stability of the bonds between themselves and compounds comprising amino groups.

FIG. 11 depicts a weft-knit fabric made of multifilament threads on the basis of hyaluronan which has been selectively oxidized to aldehyde in the position 6 of its N-acetyl-D-glucosamine group.

FIG. 12 depicts a combined warp-knit fabric, wherein the weft is formed by a multifilament thread on the basis of hyaluronan, which has been selectively oxidized to aldehyde in the position 6 of its N-acetyl-D-glucosamine group, and the warp is formed by PES filaments.

FIG. 13 depicts a tubular weft-knit fabric made of multifilament threads on the basis of hyaluronan which has been selectively oxidized to aldehyde in the position 6 of its N-acetyl-D-glucosamine group.

FIG. 14 depicts a warp-knit fabric made of composite multifilament threads containing fibres on the basis of hyaluronan, which has been selectively oxidized to aldehyde in the position 6 of its N-acetyl-D-glucosamine group, and PLLA fibres.

FIG. 15 depicts a plain-weave fabric made of multifilament threads on the basis of hyaluronan which has been selectively oxidized to aldehyde in the position 6 of its N-acetyl-D-glucosamine group.

### EXAMPLES OF PREFERRED EMBODIMENTS OF THE INVENTION

Unless otherwise specified, all the molecular weights (MW) stated in the present patent application refer to mean molecular mass values.

### Example 1

### Preparation of a Monofilament by Extruding the Initial Solution into the Mixture Containing 80% of Propane-2-Ol, 16% of Lactic Acid and 4% of Water

2.5 grams of hyaluronan oxidized in position 6 of its N-acetyl-D-glucosamine group having MW of 476 kDa were being dissolved in demineralized water for 16 hours under laboratory temperature in order to provide a clear homogenous viscous solution with the concentration of 5%. The solution was transferred into a cylinder extruder and made free of bubbles.

The extruder consisting of a cylinder and a piston was inserted into a precise linear metering device and the value of 200 μl/min was set for the extrusion rate. The solution was extruded through a spinning mono nozzle having the outlet diameter of 500 μm into the coagulation solution containing 16% of lactic acid, 80% of propane-2-ol and 4% of water. Afterwards, the formed filament was being continually wound up in pure isopropanol under room temperature for 4 hours. After the lapse of the above period of time, a sufficient solidification of the filament was achieved. Subsequently, the filament was being dried under pressure, which had been reduced to 25 mbar (2.5 kPa), and under the temperature of 60° C. for 8 hours.

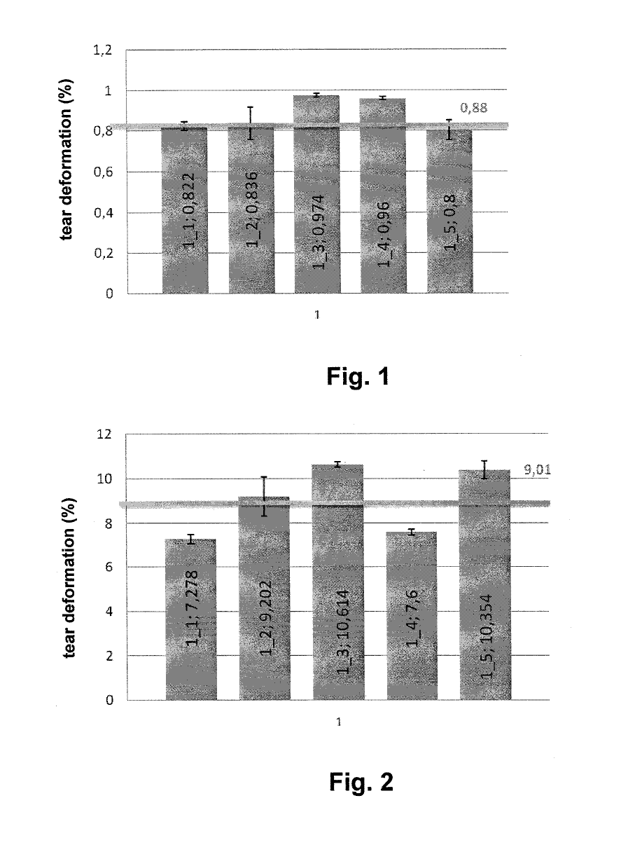

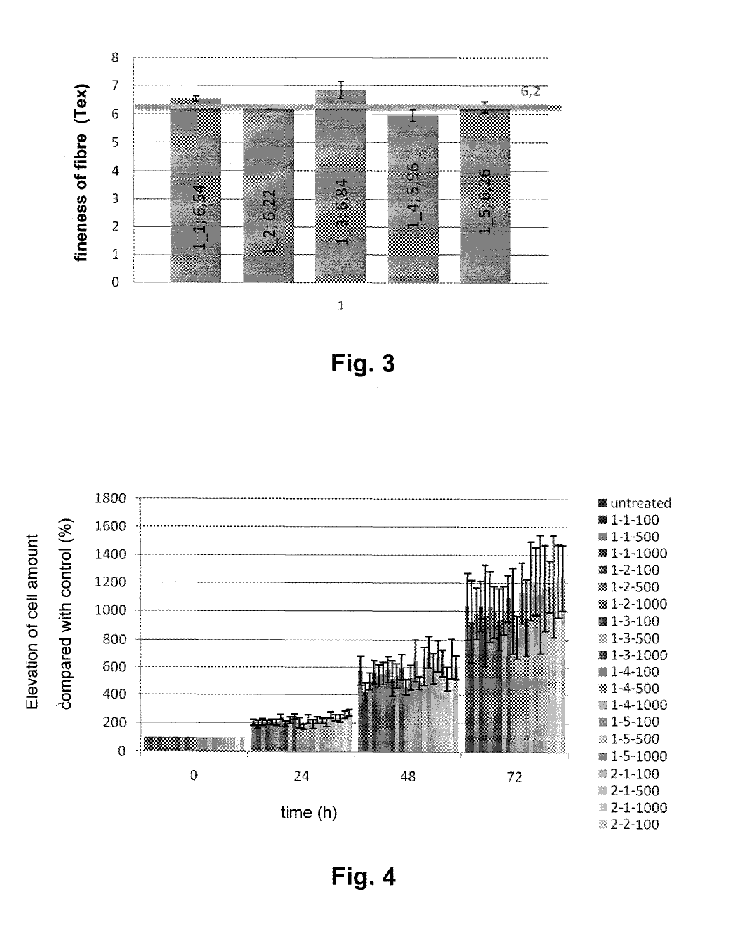

After having been prepared in the above described manner, the endless monofilaments exhibited the tear strength of 0.88 N (FIG. 1) and tear deformation of 9.01% (FIG. 2). The final fineness of the filaments measured was 6.2 Tex (FIG. 3). After having been submerged in water, the filament became completely dissolved (a complete loss of visual contact occurred) within approximately 40 minutes.

### Example 2

### Preparation of a Monofilament by Extruding the Initial Solution into the Mixture Containing 80% of Ethanol, 16% of Lactic Acid and 4% of Water

1.5 grams of hyaluronan oxidized in position 6 of its N-acetyl-D-glucosamine group having MW of 662 kDa were being dissolved in demineralized water for 12 hours under laboratory temperature in order to provide a clear homogenous viscous solution with the concentration of 4%. The gel-like solution was centrifugally made free of bubbles. The extruder consisting of a cylinder and a piston was inserted into a precise linear metering device and the value of 200 μl/min was set for the extrusion rate. The solution was extruded through a spinning mono nozzle having the outlet diameter of 500 μm into the coagulation solution containing 16% of lactic acid, 80% of denatured ethanol and 4% of water. Afterwards, the formed filament was being continually wound up in denatured ethanol (denatured with 10% of propane-2-ol) for 4 hours and then dried under pressure, which had been reduced to 25 mbar (2.5 kPa), and under the temperature of 60° C. for 8 hours.

After having been prepared in the above described manner, the endless monofilaments exhibited the tear strength of 0.82 N and increased tear deformation of 13.75%. The final fineness of the filaments measured was 6.31 Tex. The residual amounts of process agents were as follows: 0.2% of lactic acid, 0.015% of ethanol, 0.08% of propane2-ol. After having been submerged in water, the filament became completely dissolved (a complete loss of visual contact occurred) within 43 minutes.

### Example 3

### Preparation of a Monofilament by Extruding the Initial Solution into the Mixture Containing 60% of Propane-2-Ol, 32% of Lactic Acid and 8% of Water

0.8 grams of hyaluronan oxidized in position 6 of its N-acetyl-D-glucosamine group having MW of 631 kDa were being dissolved in demineralized water for 12 hours under laboratory temperature in order to provide a clear homogenous viscous solution with the concentration of 5%. The gel-like solution was centrifugally made free of bubbles. The extruder consisting of a cylinder and a piston was inserted into a precise linear metering device and the value of 200 μl/min was set for the extrusion rate. The solution was extruded through a spinning mono nozzle having the outlet diameter of 500 μm into the coagulation solution containing 32% of lactic acid, 60% of propane-2-ol and 8% of water. Afterwards, the formed filament was being continually wound up in propane-2-ol for 4 hours and then dried under the pressure, which had been reduced to 25 mbar (2.5 kPa), and under the temperature of 60° C. for 8 hours.

After having been prepared in the above described manner, the endless monofilaments exhibited the tear strength of 0.79 N and tear deformation of 10.21%.

### Example 4

### The Viability Test of Filaments without Modified External Structures

After having been prepared from aldehydic hyaluronan, the filaments were dissolved in a cultivating medium (Dulbecco's Modified Eagle's Medium containing 10% fetal bovine serum and penicillin/streptomycin (100 U/ml/100 μg/ml)) and the obtained solution were added to the 3T3 cells inoculated in a panel having 96 wells, the final density being 3000 c/w. The viability was being determined by means of the MTT test for 24-72 hours. During that test, the substance Thiazolyl Blue Tetrazolium Bromide (MTT) was dissolved in a cultivating medium and then 20 μl of the final MTT solution having the concentration of 5 mg/ml were added into each well. The incubation was taking place for 2.5 hours. Afterwards, the medium was drawn off and 220 μl of a solubilizing solution were added into each well by means of a pipette. During the subsequent incubation (lasting 30 minutes) the metabolized formazan was completely dissolved. Subsequently, the absorbance was measured by means of the VERSAmax microplate reader at 570 and 690 nm.

Five independent repeated measurements were performed. During the subsequent data processing, the Student's t-test involving a pair of samples was used, the value p≦0.05 being considered significant.

In every case, the fact was proven that the material of the fibres subjected to the test does not reduce the viability of the cells (FIG. 4).

### Example 5

### External Modification of a Filament with Dihydrazides of Adipic, Succinic and Pimelic Acids

30 mg (about 5 m) of a filament on the basis of oxidized hyaluronan were put into a large Petri dish containing the reactive bath, which was composed of 70% ethanol solution, and dissolved dihydrazide of adipic acid having the concentration of 5.10⁻³M. Then, the reactive mixture containing the filament was left at the laboratory temperature for 2 hours. Subsequently, the filament was washed in 80% ethanol and left to dry under the temperature of 40° C. for 20 minutes.

The modified filament was subject to the solubility test in demineralized water. During the test, the filament became slightly swollen but then exhibited a sufficient stability for at least 1 week. On the contrary, the test in PBS has proven the instability of the filament since the latter became totally dissolved within 24 hours. This fact indicates that only a external cross-linked layer was formed which was not sufficiently resistant to the swelling processes in the core of the filament caused by the effect of the increased ionic force of the buffer solution.

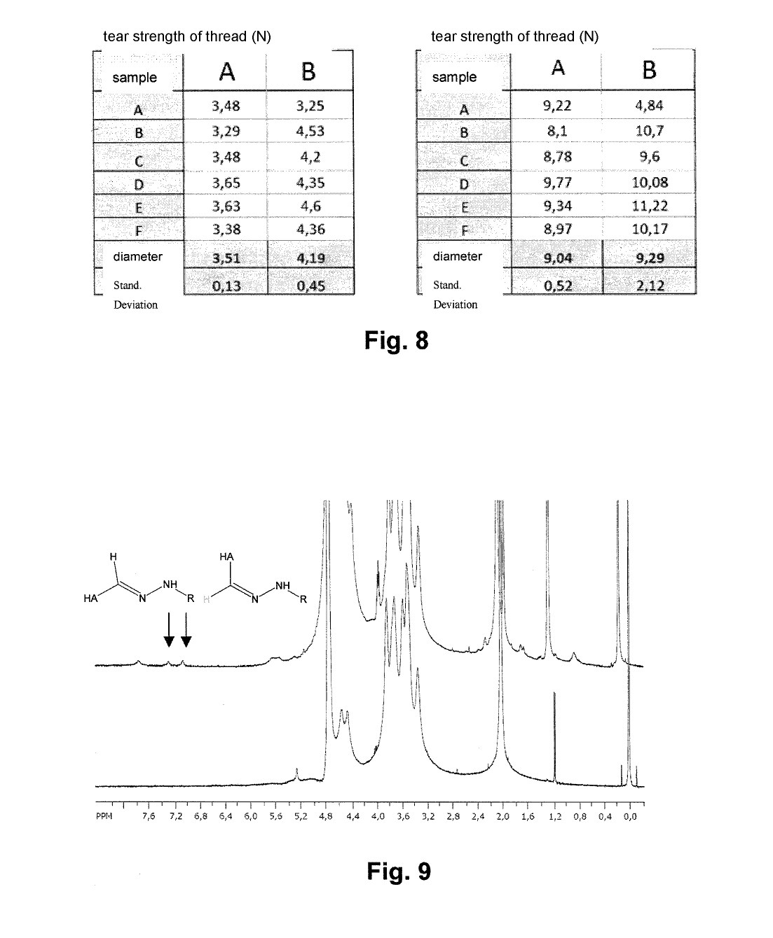

In the case that dihydrazides of succinic and pimelic acids were used, the filaments exhibited a similar behaviour. The existence of a external reaction causing the creation of hydrazone-based structural bonds has been proven by means of NMR (FIG. 8). The formation of a cross-linked structure has been further proven by the insolubility test of the modified material which was exposed to water.

### Example 6

### Thermal Modification of a Filament on the Basis of Hyaluronan Oxidized in the Position 6 of its N-Acetyl-D-Glucosamine Group—Conversion to unsaturated α,β-aldehydes

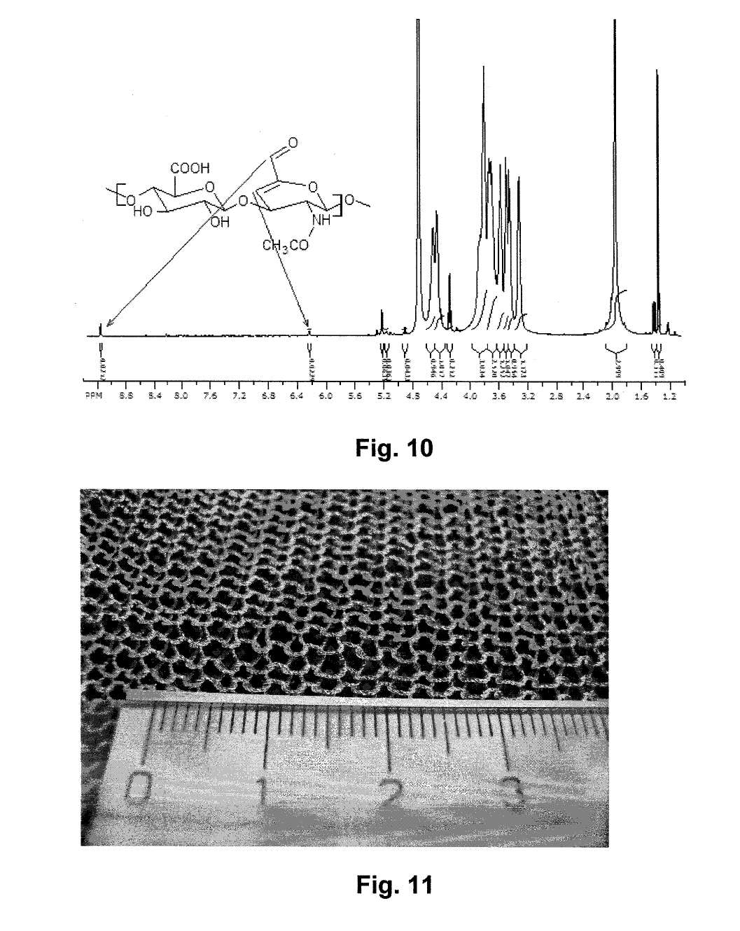

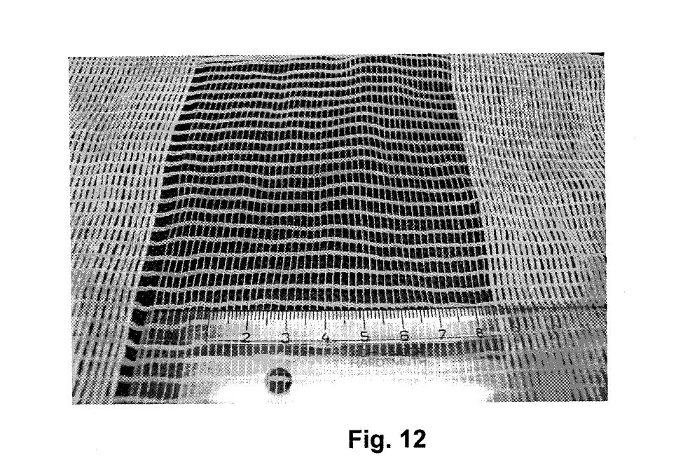

0.5 grams of prepared filaments having 120 μm in diameter and being in dry state were put into a Petri dish and then placed into a hot-air drier where the filament were being exposed to the temperature of 80° C. for 18 hours. Afterwards, the filaments were left to cool down under room temperature. The filaments were subject to an NMR structural analysis which has confirmed that the thermal exposure caused an eliminating reaction to occur and a conjugated double bond between the skeletal carbon units C4 and C5 to form (see Scheme 1b). The record of the respective NMR analysis is shown in FIG. 10. Subsequently, the filament was being modified in the solution of 1,6-diaminohexanu for 8 hours. After having been dried, it was submerged in demineralized water. In comparison with an unmodified control sample, increased hydrolytic resistance persisting for at least 12 hours has been confirmed.

### Example 7

### Toxicity Testing of Degradation Products

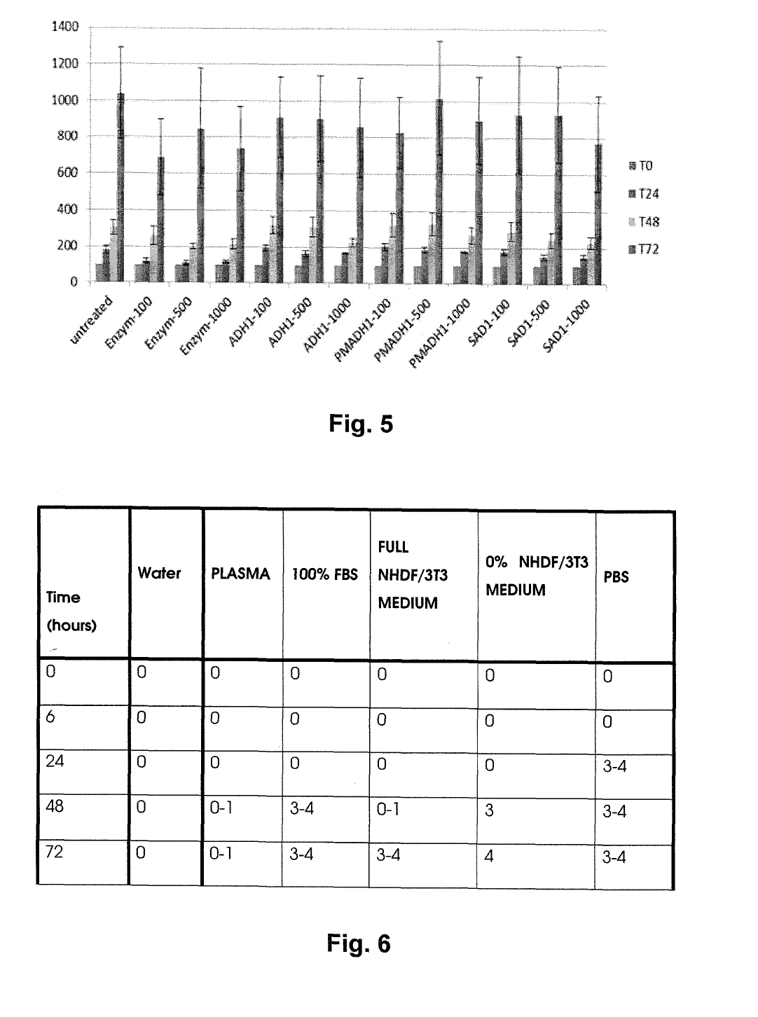

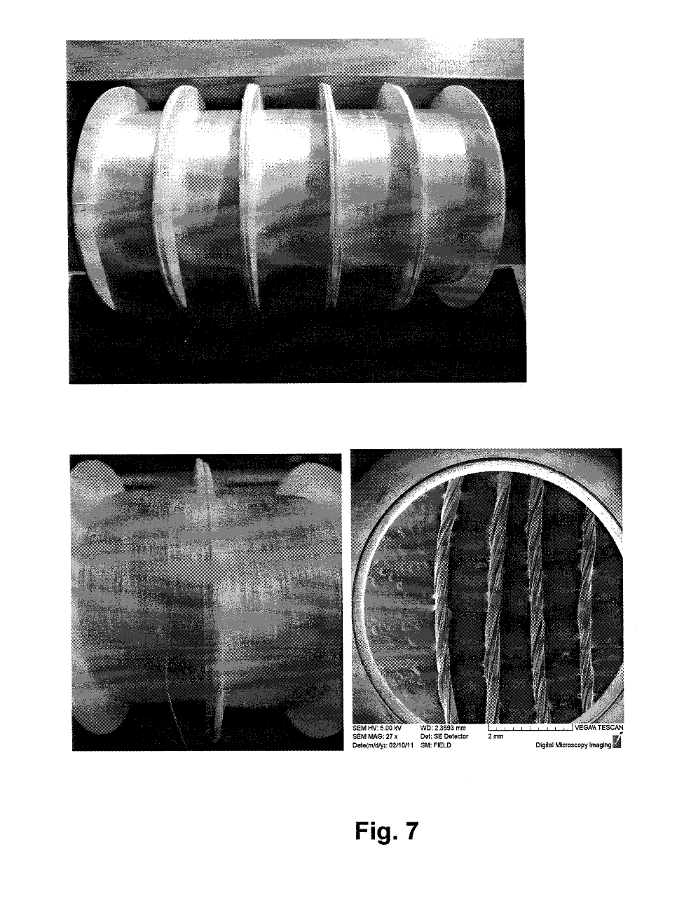

The samples of the filaments, which had been cross-linked by means of dihydrazides of succinic, adipic and pimelic acids and were present in the form of a solution having the concentration of 20 mg/ml, were supplemented with the acetate buffer solution (500 μl) containing 500 units of bovine testicular hyaluronidase. The incubation under the temperature of 37° C. was taking place for 96 hours. 500 μl of degradation products were diluted into 20 ml of a cultivating medium (Dulbecco's Modified Eagle's Medium containing 10% fetal bovine serum and penicillin/streptomycin (100 U/ml/100 μg/ml)) and, subsequently, the mixture was used for influencing the cells of the 3T3 line. Based on the concentration, from which the supernatant had been prepared, the concentration subject to testing were 1000, 500 and 100 μg/ml. It has been experimentally proven that the degradation products of the fibres, which are externally modified with dihydrazides, are not toxic against the tested cells (FIG. 5).

### Example 8

### Formation of a Multifilament Thread from Endless Monofilaments

Five monofilaments prepared from hyaluronan oxidized in the position 6 of its N-acetyl-glucosamine group and having the fineness range of 6-7 Tex were placed onto a twisting frame. Before twisting, the filaments were conditioned in an exsiccator over a saturated aqueous solution of NaBr, the desired final moisture content being approximately 60%. The increase of the moisture content of the filaments made the same more flexible and, thus, more tear resistant during the subsequent twisting process. The following twisting parameters were set: feed rate 4 m/min, velocity of the spindle 1,400 m/min, weight of the traveller 60 mg. The filaments were twisted to form a twisted thread having 350 μm in diameter. Afterwards, the mechanical characteristics of the thread were measured. (FIG. 8).

### Example 9

### Formation of a Compound Monofilament Thread from Filaments on the Basis of Oxidized Hyaluronan (67%) and PLLA Filaments (33%)

Two monofilaments prepared from hyaluronan oxidized in the position 6 of its N-acetyl-D-glucosamine group and having the fineness of 8 Tex and one PLLA filament having the fineness of 6.5 Tex were placed onto a twisting frame. Before twisting, the filaments were being conditioned for 24 hours in order to obtain the moisture content ranging from 45 to 50%. Such increase of the moisture content of the filaments makes the same more flexible and, thus, more tear resistant during the subsequent twisting process. The following twisting parameters were set: feed rate 5 m/min, velocity of the spindle 1,500 m/min, weight of the traveller 50 mg. The filaments were twisted to form a thread having from 130 to 170 μm in diameter. The thread exhibited the following mechanical characteristics: tensile strength of 2.3±0.2 N, elongation of 16.5±1.7% and knot strength of 1.2±0.3N.

### Example 10

### Weft-Knit Fabric Made of Filaments on the Basis of Hyaluronan Oxidized in Position 6 of its N-Acetyl-D-Glucosamine Group

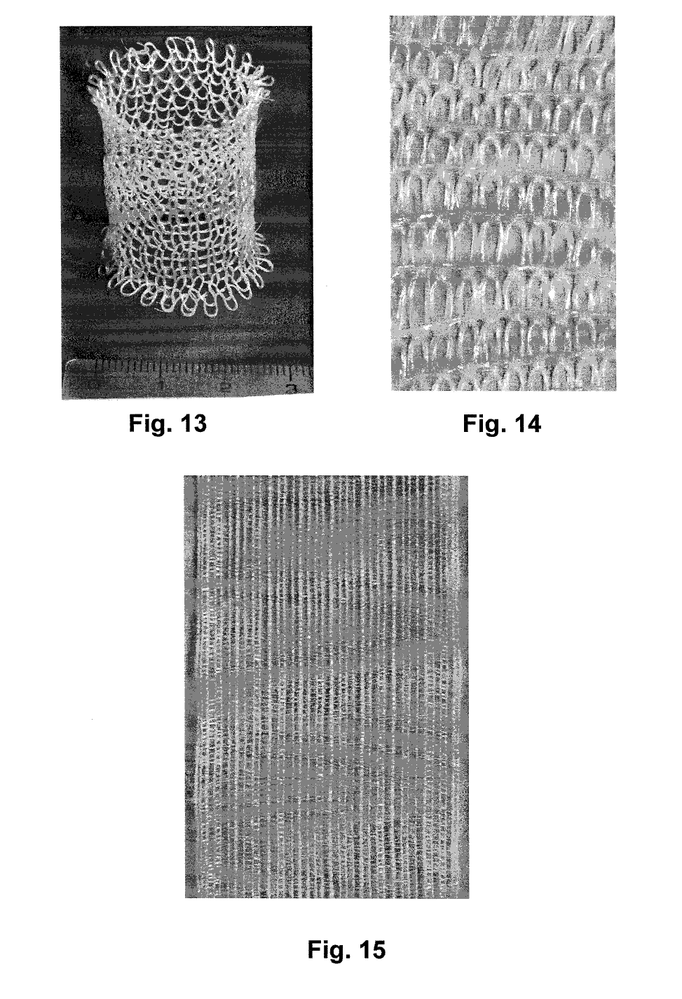

The threads, which had been prepared similarly to those described in Example 8, were twisted in a ring-type twisting frame to form a triple twisted thread. Afterwards, the thread was processed in a Harry Lucas circular knitting machine having the working diameter of 1½′ and the needle gauge 5 G to form a tubular knitted fabric (FIG. 13). The finished plain weft-knit fabric exhibited the basis weight of 110 g/m², the course density of 5 loops/cm and the wale density of 3.5 loops/cm. (FIG. 10).

### Example 11

### Warp-Knit Fabric Made of Compound Threads Prepared from Filaments on the Basis of Oxidized Hyaluronan and from PLLA Filaments

The threads, which had been prepared similarly to those described in Example 9, were twisted in a ring-type twisting frame to form a double twisted thread. Afterwards, the necessary warp was formed on a drum-type warping frame. The warp was rewound onto a warp beam. The warp beam was placed into the warp knitting machine (knitting crochet machine, Rius) equipped with spring-hook needles, the needle gauge being 11 G. The warp threads were drawn into lapping guides and knitting needles and knitted to form a chain stitch. Thus, a knitted fabric was manufactured having its chain-stitches interlaced by a front weft (FIG. 11).

### Example 12

### Fabric Made of Filaments Prepared from Hyaluronan Oxidized in Position 6 of its N-Acetyl-D-Glucosamine Group

The necessary warp was formed on a drum-type warping frame, the respective warp threads having been prepared similarly to those described in Example 8. Afterwards, the warp was rewound onto a warp beam. The warp beam was attached to a shuttle type-ribbon loom and the warps threads were drawn into the healds and into the reed. The weft thread having the same composition was rewound onto the bobbin which was inserted into the shuttle. The necessary parameters of the shedding and picking mechanisms were adjusted in order to obtain a plain weave having the desired pitch values of warp and weft threads. The finished plain-weave fabric exhibited the basis weight of 75 g/m², warp-thread pitch of 10 threads/cm and weft-thread pitch of 20 threads/cm (FIG. 15).

### CITED LITERATURE

1. Hladik, V., Textile fibres, SNTL 1970, ISBN 04-834-70
2. WO2009/050389—FILAMENT CONTAINING HYALURONIC ACID IN FREE ACIDIC FORM AND METHOD FOR MAKING SAME
3. PV2010-1001—Hyaluronan filaments, method for preparation the same and application of the same
4. US2006/0281912 A1—Hyaluronan (ha) esterification via acylation technique for moldable devices
5. WO2010095049A1—CROSSLINKED FIBERS AND METHOD OF MAKING SAME BY EXTRUSION
6. WO2010095056 A2—MEDICAL DEVICES WITH AN ACTIVATED COATING
7. WO2010061005—METHOD TO PRODUCE HYALURONIC ACID FUNCTIONALIZED DERIVATIVES AND FORMATION OF HYDROGELS THEREOF
8. WO1993/011803 A1—NON-WOVEN FABRIC MATERIAL COMPRISING HYALURONIC ACID DERIVATIVES
9. WO1998008876 A1—HYALURONIC ACID ESTERS, THREADS AND BIOMATERIALS CONTAINING THEM, AND THEIR USE IN SURGERY
10. U.S. Pat. No. 5,658,582—Multilayer nonwoven tissue containing a surface layer comprising at least one hyaluronic acid ester
11. US2004/0192643 A1—Biomaterials for preventing post-surgical adhesions comprised of hyaluronic acid derivatives
12. WO2011069475—A METHOD OF PREPARATION OF AN OXIDIZED DERIVATIVE OF HYALURONIC ACID AND A METHOD OF MODIFICATION THEREOF
13. WO2011/069474—OXIDIZED DERIVATIVE OF HYALURONIC ACID, A METHOD OF PREPARATION THEREOF AND A METHOD OF MODIFICATION THEREOF
14. US2004/0101546 A1—Hemostatic wound dressing containing aldehyde-modified polysaccharide and hemostatic agents
EP1115433 B1—FUNCTIONALIZED DERIVATIVES OF HYALURONIC ACID, FORMATION OF HYDROGELS AND IN SITU USING SAME
16. WO2010138074 A1—HYALURONIC ACID BASED DELIVERY SYSTEMS
17. WO2009108100 A1—COMPOSITION FOR THE FORMATION OF GELS

1. Preparation of fibres based on hyaluronan selectively oxidized in the position 6 of its N-acetyl-D-glucosamine group, characterized in that first an aqueous solution of oxidized hyaluronan having the concentration of 4-6% by weight is prepared, which solution is then extruded into a coagulation bath containing lactic acid in the amount ranging between 5 and 45% by weight, a lower alcohol in the amount of at least 50% by weight and water in the amount ranging between 4 and 10% by weight, causing a fibre to form, which is subsequently washed with a lower alcohol and dried.

2. Preparation according to claim 1, characterized in that the lower alcohol used for washing the fibre is selected from the group comprising ethanol, 1-propanol and isopropanol.

3. Preparation according to claim 1, characterized in that the lower alcohol used in the coagulation bath is selected from the group comprising ethanol, 1-propanol and isopropanol.

4. Preparation according to claim 1, characterized in that the concentration of lactic acid in the coagulation bath ranges between 10 and 20% by weight.

5. Preparation according to claim 1, characterized in that after having been dried, the fibres are externally modified in that they are submerged in a stabilizing bath containing a 70-80% aqueous solution of a lower alcohol, in which alcoholic solution a low molecular dihydrazide of an organic acid is dissolved in the concentration from 5×10⁻⁶M to 0.01 M, under the temperature ranging between 20 and 50° C. for a time period between 10 minutes and 24 hours, and subsequently the fibres are washed with a lower alcohol and dried again.

6. Preparation according to claim 5, characterized in that the lower alcohol used in the stabilizing bath is selected from the group comprising methanol, ethanol, propane-1-ol and propane-2-ol.

7. Preparation according to claim 5, characterized in that the low molecular dihydrazide of an organic acid is selected from the group comprising dihydrazide of succinic acid, dihydrazide of adipic acid or dihydrazide of pimelic acid.

8. Preparation according to claim 5, characterized in that the low molecular dihydrazide of an organic acid is present in the stabilizing bath in the concentration of 5×10⁻³M.

9. Preparation according to claim 1, characterized in that the fibres are subjected to thermal loading within the temperature range from 75 to 85° C. for at least 12 hours, whereupon they are left to dry under a laboratory temperature and then they are subjected to the action of organic diamino compounds in order to become stabilized against hydrolysis.

10. Fibres on the basis of hyaluronan oxidized in position 6 of its N-acetyl-D-glucosamine group.

11. Fibres according to claim 10, characterized in that they are externally cross-linked.

12. Application of the fibres according to claim 10 for the manufacture of tows, threads, yarns, fibrous staples and woven, knitted or nonwoven fabrics.

13. Thread formed by at least two fibres according to claim 10.

14. Thread formed by at least two fibres, characterized in that at least one fibre is that according to claim 10 and at least one fibre is that selected from a group comprising fibres made of other biodegradable materials.

15. Fibrous staple made of fibres according to claim 10.

16. Yarn made of the fibrous staple defined in claim 15.

17. Woven, knitted and non-woven fabrics made of fibres, tows, threads, yarns or fibrous staples defined in any of the claims 10, 11, and 13 to 16.

18. Woven, knitted and non-woven fabrics made of fibres, tows, threads, yarns or fibrous staples defined in any of the claims 10, 11, and 13 to 16 in combination with other biodegradable fibrous materials.

19. Woven, knitted and non-woven fabrics according to any of the claim 17 or 18, characterized in that they are present in the form of a planar or tubular fabric or in the form of a 3D scaffold.

20. Method for modifying the fibres, threads, fibrous staples, yarns and woven, knitted or non-woven fabrics defined in any of the claims 10 to 19, characterized in that the same are subjected to the action of an aqueous alcoholic solution having the concentration between 70 and 80% and containing a low molecular dihydrazide of an organic acid, the dihydrazide being present in the solution in a concentration between 5×10⁻⁶M to 0.01 M, under the temperature between 20 and 50° C. for a time period between 10 minutes and 24 hours.

21. The method according to claim 20, characterized in that the low molecular dihydrazide of an organic acid is selected from the group comprising dihydrazide of succinic acid, dihydrazide of adipic acid or dihydrazide of pimelic acid.
